(19) United States
(12) Patent Application Publication
(10) Pub. No.: US 2012/0004778 A1
(43) Pub. Date: Jan. 5, 2012

(54) Vacation Faucet Apparatus and Method

(76) Inventors: Jackie Lai, Sunnyvale, CA (US); Anurupa Rao, Sunnyvale, CA (US); Lesley Silverthorn, Redwood City, CA (US); Todd Pope, Napa, CA (US)

(21) Appl. No.: 13/098,159

(22) Filed: Apr. 29, 2011

Related U.S. Application Data
(60) Provisional application No. 61/329,419, filed on Apr. 29, 2010.
(60) Provisional application No. 61/371,601, filed on Aug. 6, 2010.

(51) Int. Cl. G05D 9/00

(52) U.S. Cl. 700/282

(57) ABSTRACT

A system and method for preventing damage and undesirable situations/conditions from occurring in point of use (POU) or point of entry (POE) water systems that are not in regular use. This invention may be implemented in residential, non-residential situations or constructions where it can add value, such as commercial properties that undergo seasonal and/or other periods of disuse. In cold climate areas, faucets should be turned on and run to prevent water in the pipes from freezing, which can cause pipes to burst or leak and result in significant property damage. In all climates rust, corrosion, particles, contamination, and biofilm, can develop and/or settle in the pipes if faucets are not turned on periodically, resulting in sub-standard water quality when the system is eventually used. Also, if water is left to sit in residential pipes, other effects/conditions can take place over time that generally effect color, taste and order of the water if it does not periodically move through the system.

### RELATED APPLICATIONS

This application claims priority from U.S. provisional application No. 61/329,419 filed on Apr. 29, 2010 and U.S. Provisional application No. 61/371,601 filed on Aug. 6, 2010 which are incorporated by reference herein in their entirety.

### FIELD OF THE INVENTION

The invention relates to the field of faucets and more particularly to the operation of faucets in locations where there are long periods of non-use.

### BACKGROUND OF THE INVENTION

Homes and buildings run a risk of damage and other undesirable situations/conditions from occurring in point of use (POU) or point of entry (POE) water systems that are not in regular use. For example, in cold climate areas, water in the pipes may freeze which can cause pipes to burst or leak and result in significant property damage. In all climates rust, corrosion, particles, contamination, and biofilm, can develop and/or settle in the pipes in periods of non-use resulting in sub-standard water quality when the system is eventually used.

### SUMMARY OF THE INVENTION

A computer based method for flushing a plumbing system including: determining a first period representing a time during which a flow rate through the plumbing system is lower than a first flow rate threshold; determining a first flush protocol representing a flushing of a portion of said plumbing system; and generating a control signal by the computer to implement said first flush protocol if said first period exceeds a first time threshold. In various embodiments said first flush protocol uses at least one of hot water and/or cold water, said plumbing system comprises multiple faucets, said plumbing system comprises a single faucet.

A computer based method for flushing a plumbing system comprising: monitoring a first characteristic of water in the plumbing system; determining when a first value representing said first characteristic is outside a first range; determining a first flush protocol representing a flushing of a portion of said plumbing system; and generating a control signal by the computer to implement said first flush protocol if said first value is outside said first range. In various embodiments said first characteristic is a temperature of the water, said first flush protocol uses at least one of hot water and/or cold water, said plumbing system comprises multiple faucets, and said plumbing system comprises a single faucet.

A computer based method for flushing a plumbing system comprising: monitoring a first characteristic of water in the plumbing system; determining when a first value representing said first characteristic is outside a first range; determining a first period representing a time during which said first value is outside said first range; determining a first flush protocol representing a flushing of a portion of said plumbing system; and generating a control signal by the computer to implement said first flush protocol if said first value is outside said first range and said first period exceeds a first time threshold. In various embodiments said first characteristic is one of a temperature of water, a temperature of air near the plumbing system, and/or a pressure of water in the plumbing system. In an embodiment the system and method further includes determining a second period representing a time during which a flow rate through the plumbing system is lower than a first flow rate threshold; and wherein said generating step generates a control signal by the computer to implement said first flush protocol if said first value is outside said first range and said first period exceeds a first time threshold and said second period exceeds a first time threshold.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a figure of the environment in which the invention operates in accordance with an embodiment of the present invention.

FIG. 2 is flowchart of the operation of a vacation mode embodiment of the present invention.

FIG. 3 is an illustration of a vacation mode system in accordance with an embodiment of the present invention.

FIG. 4 is an illustration of a vacation mode system with an integrated timer in accordance with an embodiment of the present invention.

FIG. 5 is an illustration of a vacation mode system with a pressure sensor and controllable valves in accordance with an embodiment of the present invention.

FIG. 6 is an illustration of a vacation mode system in accordance with an embodiment of the present invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

A preferred embodiment of the present invention is now described. Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

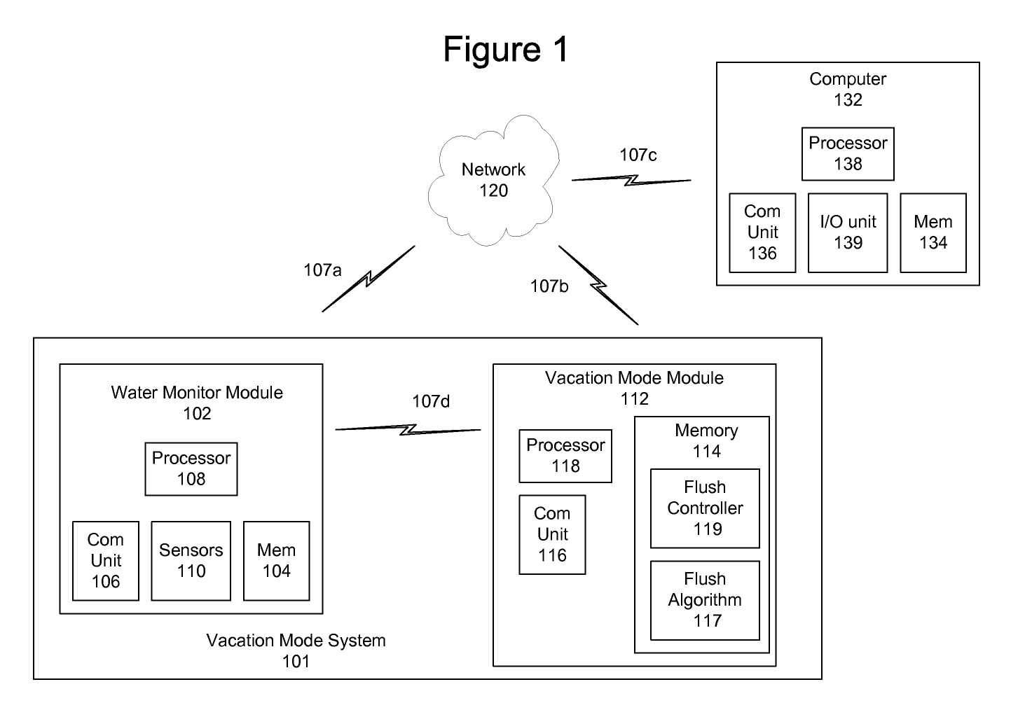

FIG. 1 is a figure of the environment in which the invention operates in accordance with an embodiment of the present invention. The operating environment may include a vacation mode monitor 112 which can include a processor 118, a memory device 114 and a communications unit 116. The operating environment may include a communication link 107 for communications between the vacation mode module monitor 112, a network 120, a water monitor module 102 and/or a computer 132. The communication links described herein can directly or indirectly connect these devices (using communication units 106, 116 and/or 136, for example). The network 120 can be, for example, a wireline or wireless communication network such as a WiFi, other wireless local area network (WLAN), a cellular network comprised of multiple base stations, controllers, and a core network that typically includes multiple switching entities and gateways. Other examples of the network 120 include the Internet, a public-switched telephone network (PSTN), a packet-switching network, a frame-relay network, a fiber-optic network, combinations thereof, and/or other types/combinations of networks. The combination of the Water Monitor module 102 and the vacation mode module 112 is referred to as the Vacation Mode system 101.

Processors 108, 118 and/or 138 process data signals and may comprise various computing architectures including a complex instruction set computer (CISC) architecture, a reduced instruction set computer (RISC) architecture, or an architecture implementing a combination of instruction sets. Although only a single processor is shown in FIG. 1, multiple processors may be included. The processors can comprise an arithmetic logic unit, a microprocessor, a general purpose computer, or some other information appliance equipped to transmit, receive and process electronic data signals from the memory 104, 114, 134 and other devices both shown and not shown in the figures.

The computer 132 can be any computing device capable of executing computer modules/code for the functions described herein. For example, the computer can be a personal computer (PC) running on a Windows operating system that is commercially available from Microsoft Corp, Redmond, Wash., a computer running the Mac OS (and variations of) that is commercially available from Apple Computer, Inc., Cupertino, Calif., or other operating systems, a personal device assistant (PDA), a smart phone, e.g., an iPhone, commercially available from Apple Computer Inc. or a phone running the Android operating system, commercially available from Google, Inc, Mountain View, Calif. Other examples include a smart-watch, at tablet computer, e.g., the iPad (commercially available from Apple Computer, Inc) or any other device that can communicate with a network. For ease of discussion, the computer 132 will be described as a personal computer. The computer 132 includes a processor 138, as described above, a communication unit 136 for communicating with the network 120 (for example), a memory module 134, such as the memory modules described herein and an input/output unit 139 that can include input devices, e.g., keyboard, touch screen, mouse and output devices, e.g., a display.

The memory modules 104, 114 and/or 134 can be volatile and/or non-volatile memory, e.g., the memory may be a storage device such as a non-transitory computer-readable storage medium such as a hard drive, compact disk read-only memory (CD-ROM), DVD, or a solid-state memory device. The memory 104/114/134 can be physically part of the water monitor module 102, the vacation mode module 112 and/or the computer 132 or can be remote from them, e.g., communicatively coupled to the water monitor module 102, the vacation mode module 112 and/or the computer 132 via a wired/wireless connection 107, via a local area network (LAN), via a wide area network (WAN), via the Network 120, directly connected, etc. For ease of discussion the memory 104/114/134 is described herein as being part of the water monitor module 102/vacation mode module 112/computer 132.

Water monitor module 102 can include sensors such as a flow sensor, temperature sensor (of water and/or air), pressure sensor, turbidity sensor, water impurities/components/particulates sensor, e.g., to measure lead, chlorine, etc, strain gauges, and/or other sensors to monitor levels or one or more consumables (e.g., salt in a system that has the function to soften water). Examples of a water flow sensor include a propeller/turbine meter, differential pressure meter, vortex meter, ultrasonic meter, rotameter, or any other flow meter type. The system may also have sensors that monitor the condition of system elements such as a sacrificial zinc electrode.

Vacation mode module 112 includes a processor 118, a communication unit 116 and a memory module that can include a flush controller 119 and a flush algorithm 117. As described herein, the flush controller can be a program to determine when a flush event should occur and can select a flush algorithm from the flush algorithm module 117 to perform the system flushing algorithm/protocol identified to meet the system goals. An optional input/output unit can be part of the water module 102, vacation mode module 112 and/or vacation mode system 101.

This invention is a system and method for preventing damage and undesirable situations/conditions from occurring in residential point of use (POU) or point of entry (POE) water systems that are not in regular use. This invention may also be implemented in non-residential situations or constructions where it can add value, such as commercial properties that undergo seasonal and/or other periods of disuse. In cold climate areas, faucets need to be turned on and run to prevent water in the pipes from freezing, which can cause pipes to burst or leak and result in significant property damage. In all climates rust, corrosion, particles, contamination, and biofilm, can develop and/or settle in the pipes if faucets are not turned on periodically, resulting in sub-standard water quality when the system is eventually used. Also, if water is left to sit in residential pipes, other effect/conditions can take place over time that generally effect color, taste and order of the water if it does not periodically move through the system.

A system and method is disclosed herein that prevents plumbing and other property damage caused by freezing, as well as the unwanted build up of biofilms, contaminants, sediments and/or particles. Referred to herein as a “vacation system”, the vacation system can employ various embodiments of sensing unwanted conditions, plumbing events, and user interactions with the plumbing system. It can also acquire data from other equipment and sensors including motion sensors, timers, clocks, alarm systems and home automation systems, and can send data back to these and other equipment.

Various information gathering sensors and monitors can be used with this vacation system—the specific sensors and/or monitors can be based on the needs of the end user, the design of the residential plumbing system, the conditions under which the water system and vacation system would be used, and the features of the implemented vacation system. One embodiment would use a central flow sensor on the main input water line to the residential location. This flow sensor can be a propeller/turbine meter, differential pressure meter, vortex meter, ultrasonic meter, rotameter, or any other flow meter type appropriate with application.

In an embodiment the system has sensors such as temperature probes that can gather information about the temperature of the water in various locations of the residential plumbing system that is being monitored. They can measure the water temperature directly, measure the temperature of the pipes, and measure the temperature of the water flowing out of one or more faucets. The system can also measure residential interior air temperature, exterior air temperature, air temperature of non-living space (e.g. equipment areas) as well as gather temperatures from other equipment in the residence (e.g. thermostats, alarm systems, home automation systems).

In an embodiment, optical sensors can be used to take turbidity, and other measurements of water quality parameters, as the water flows. Also, sensors/probes could be used to take real time, or periodic measurements of components in the water (e.g. lead, chlorine, etc)

An embodiment has vacation system controlled faucets that can start and stop water flow from cold and/or hot sections of one or more faucets. An additional embodiment includes automatic vacation system control the actuation of the drain stoppers in all sinks, basins, wash tubs, or reservoirs that include a vacation system controlled faucet.

In one embodiment the vacation mode system 101 monitors and acts on one faucet, which may or may not be the only one in the structure. In another embodiment, the vacation mode system 101 can monitor the usage and/or water flow from that faucet in addition to monitoring, for example, the temperature of the water in the main water line near its point of entry to the residence, the temperature of the water in the water line in the basement area, and/or the temperature of the water in the water line nearest an external wall. When the vacation system is designed and implemented, temperature readings in the winter can be taken of the water/pipes to find the worst case areas of the plumbing system, with respect to the water in the pipes being affected by the cold exterior temperatures. Also, guidelines from past installations and/or experiments can be used.

The vacation system can automatically control the faucet to allow it to turn on and off, both the hot and/or cold water exiting the faucet. This allows both hot and cold water lines to be flushed by the flush controller 119 of the vacation mode system 101. The system can gather information from temperature sensors, water impurity sensors, timers since last faucet on/off cycle, and flow volume sensors for example. This information can be used by the flush controller 119 to select an algorithm from the flush algorithm module 117 to determine if the faucet should be turned on, whether it should be the cold water line, the hot water line, or both, and how long it should be turned on for. There are various ways the flush controller 119 determines the length of time the faucet should be run for. First, it can be run for a predetermined time, either a standard time determined by the manufacturer, a time set by the user or installer, or a time that has be experimentally determined from the physics of the system (e.g., how long does it take to flush the water in the system to or achieve another vacation system goal). Second, the faucet can be turned on and while it is running, the sensors and monitors of the vacation system can provide feedback and the system turns off the faucet when the needed conditions of the sensors are met, e.g., water clarity achieves a threshold.

In one embodiment, the system can be a faucet that has some or all of the following: a processor, firmware logic, timer, a flow meter, automated controlled to turn on both cold and hot water, and a temperature sensor at the exit of the water. It can function in at least two modes.

A first mode can be an always-monitoring mode that monitors how often water exits the faucet and at what volume, per individual use and/or total volume over a period of time. In this mode, if the water volume does not meet some preset value, the vacation system can turn on the cold, hot or both water lines to flush the plumbing system. The second mode can monitor the temperature of either the cold or hot water, or both as water exits or enters the faucet. This could be for user initiated water flows and for vacation system program controlled water flows. If the vacation system determines that the faucet has not been used in a period of time, it can start a flow of water, and monitor the exit water temperature. The flush controller 119 and flush algorithm 117 can use this information to determine if a larger program initiated flush is required.

An embodiment monitors some or all individual faucets (e.g., system endpoints) for the frequency and volume of flow, as well as, other system parameters from sensors (e.g., temperature, pressure), from a central location and is able to control faucet on/off operation for the cold and/or hot sections of all the faucets using the flush controller 119.

An additional embodiment monitors central water line flow and flow at some or all the faucets.

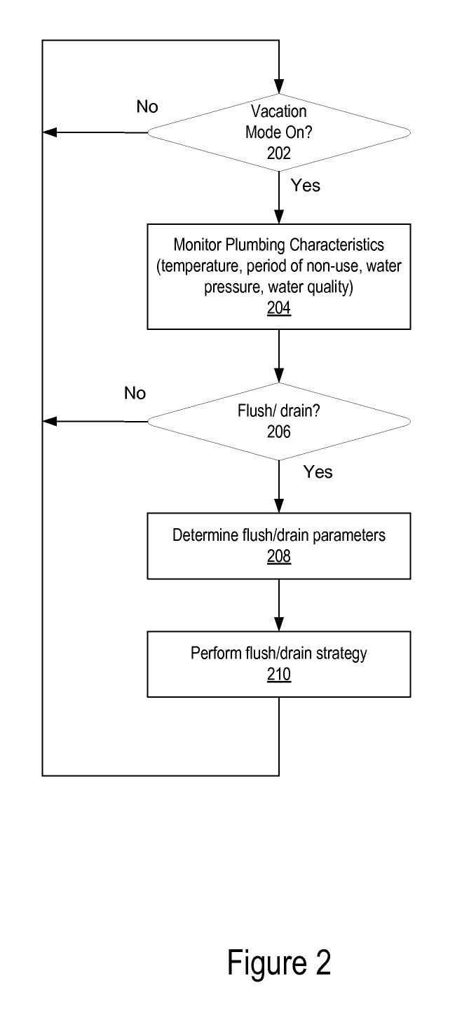

In an embodiment, the vacation system allows the user to activate a pre-determined “Vacation Mode” when the user expects to be away for a period of time. FIG. 2 is flowchart of the operation of a vacation mode embodiment of the present invention. The vacation mode operation can be based on a program stored in a vacation mode system 101 memory module 104/114, for example flush controller 119. The process determines 202 if the vacation mode is on. If 202 the vacation mode is not on then, in this embodiment the process continues checking to see when the vacation mode is turned on. In alternate embodiments, the program can end and can restart when vacation mode is selected. Also in alternate embodiments, the process shown in FIG. 2 (or a similar process) can proceed even if vacation mode is not turned on. In this embodiment, if 202 vacation mode is turned on then one or more plumbing characteristics are monitored 204. As described herein, the monitoring 204 can include the use of sensors 110 to monitor the temperature of the water, pipes or ambient air external to the plumbing, the water pressure, the water quality (e.g. specific chemicals, heavy metals, sedimentation, other measureable water characteristics, etc), the water flow to determine a period of non-use or excessive use, etc.

The vacation system further has sensing technology that communications with the flush controller 119 which enables it to self-determine when a period of non-use exists or other flush trigger 206 exists, e.g., water temperature, pressure, and to select 208 a flush algorithm 117 to perform 210 the flush strategy, e.g., to turn water on and off automatically (on/off flush regime), even if the user has not selected Vacation Mode. The on/off flush regime can continue to run at pre-set intervals until the system is reset by a user or until the system detects that the hazardous/undesirable conditions no longer exist. Detection of hazardous conditions can be achieved through a water pressure sensor, water temperature probe, strain gauges/sensors and the like. In these cases and other cases described, plumbing systems and property can be protected during periods of non-use.

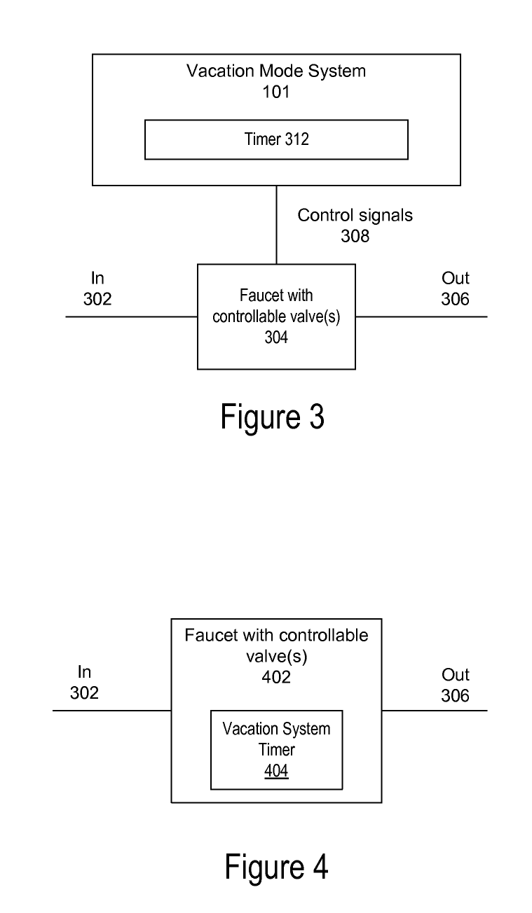

In a vacation mode embodiment, the user activates a switch when he/she expect to be away and the fixtures and water supply will not be in use, for example. FIG. 3 is an illustration of a vacation mode system in accordance with an embodiment of the present invention. FIG. 4 is an illustration of a vacation mode system with an integrated timer in accordance with an embodiment of the present invention. The vacation mode system 101 includes a timer 312 (that can be a timer program in memory 104/114, part of processor 108/118 etc), and generates control signals to control faucet 304 having controllable valves. The valve can be a conventional valve that controls the flow of liquid through the faucet, i.e., from input 302 to output 306. Examples of a valve include a solenoid valve, a pump etc. As described above, when in vacation mode or at other times the timer can be used by the flush controller 119 to identify a period of non-use or low-use. As shown in FIG. 3, the timer can be a timer 312 in vacation mode system 101, e.g., in vacation mode module 112, and/or a timer 404 integrated into one or more faucets 402 as shown in FIG. 4. A processor 108/118 in, near or coupled directly or indirectly to the faucet then activates a user specified or pre-programmed on/off flow cycle, e.g., an algorithm/protocol in the flush algorithm module 117) that controls a valve to turn on the faucet to allow water to run for a period of time before being turned off again automatically.

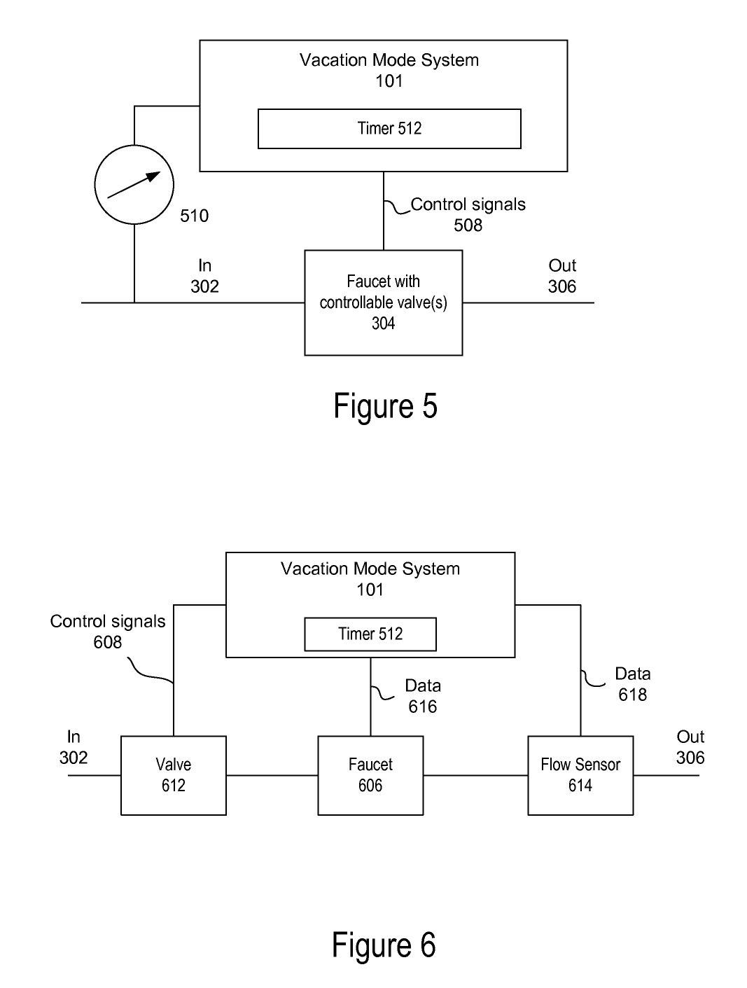

FIG. 5 is an illustration of a vacation mode system with a pressure sensor and controllable valves in accordance with an embodiment of the present invention. This embodiment measures the water pressure in the pipes, the vacation mode system 101 recognizes the patterns that freezing water causes on pressure in the plumbing system and communicates these pressure readings to a flush controller 119 that controls an on/off flush regime. Pressure in the piping system can be measured by a pressure gauge 510 with, for example, a digital output capability for communication to the vacation mode module 101 or by a pressure transducer with electrical signal transmission and communication link to the vacation mode module 101. Other methods of pressure sensing and measurement can be employed, for example, a piezoresistive strain gauge, capacitive pressure sensor, electromagnetic pressure sensor, piezoelectric pressure sensor, optical pressure sensor, potentiometric pressure sensor, resonant frequency sensor and the like. Once a pressure change is detected and communicated to the vacation mode module 101, and if the pressure is approaching a dangerous threshold or any threshold identified by a user directly or programmed into the flush controller 119, the vacation mode system 101 signals an automatic valve 304, like a solenoid valve, to open and run an on/off flush algorithm 117.

FIG. 6 is an illustration of a vacation mode system in accordance with an embodiment of the present invention. In this embodiment a vacation mode system 101 includes a timer 512 and sends control signals 608 to a valve 612 to control the flow of water to faucet 606 from the input pipes 302 to the output pipes 306. A flow sensor 614 and timer 512 are employed to determine the length of any non-use period based on intervals of measured flow through the faucet. If no flow (or only a small flow) is detected for/over a pre-determined period of time as determined by data 616/618, a user programmable or pre-programmed on/off flush algorithm, selected by the flush controller 119 from the flush algorithm module 117 is activated by the processor 108/118. This algorithm may be automatically implemented by means of a control valve 612 that is opened when it receives a signal from the vacation mode system 101. This control valve 612 can be a solenoid valve, a pump, etc. The flow sensor 614 shown in FIG. 6 is positioned after the faucet, it is envisioned that the flow sensor can be position before the faucet.

In another embodiment, a method is employed to measure the water temperature in the water supply pipe. A temperature sensor (a sensor in the sensors module 110) detects when the temperature of water in the supply pipe drops below a pre-determined threshold temperature and signals the microprocessor, which triggers a valve to open and allow water to flow (be released) at a controlled rate.

In another embodiment, a sensor measures the water quality, e.g., the presence of biofilms, settling of particulates, and/or other impurities that when sensed by the flush controller 119 cause the flush controller 119 to initiate an flush algorithm to cleanse the system.

The flush control signal 305/508/608 can also be generated remotely using, e.g., computer 132. In one embodiment, a user of computer 132 may access, either directly or indirectly, the vacation mode module 112 and instruct the flush controller 119 to initiate a flush algorithm. In an embodiment, instead of starting the flush algorithm in response to certain conditions, the flush controller 119 may contact a third party, e.g., the owner of a vacation home via email, text, etc. This real-time information or historical information can be sent to the user via a remote computer 132 coupled to the network 120, or can be an SMS message, email, instant message, etc., using conventional techniques based on software in memory 134, for example, and communicating via network 120. The user may then communicate with the overflow detection system 101, using computer 132 (for example) and monitor the situation or instruct the overflow detection system to proceed with a suggested flush algorithm or provide other instructions, e.g., provide instructions about a specific flush algorithm or separate flush protocol to be initiated or otherwise involved.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A computer based method for flushing a plumbing system comprising:
determining a first period representing a time during which a flow rate through the plumbing system is lower than a first flow rate threshold;
determining a first flush protocol representing a flushing of a portion of said plumbing system; and
generating a control signal by the computer to implement said first flush protocol if said first period exceeds a first time threshold.

2. The computer based method of claim 1, wherein said first flush protocol uses at least one of hot water and/or cold water.

3. The computer based method of claim 1, wherein said plumbing system comprises multiple faucets.

4. The computer based method of claim 1, wherein said plumbing system comprises a single faucet.

5. A computer based method for flushing a plumbing system comprising:
monitoring a first characteristic of water in the plumbing system;
determining when a first value representing said first characteristic is outside a first range;
determining a first flush protocol representing a flushing of a portion of said plumbing system; and
generating a control signal by the computer to implement said first flush protocol if said first value is outside said first range.

6. The computer based method of claim 5, wherein said first characteristic is a temperature of the water.

7. The computer based method of claim 5, wherein said first flush protocol uses at least one of hot water and/or cold water.

8. The computer based method of claim 5, wherein said plumbing system comprises multiple faucets.

9. The computer based method of claim 5, wherein said plumbing system comprises a single faucet.

10. A computer based method for flushing a plumbing system comprising:
monitoring a first characteristic of water in the plumbing system;
determining when a first value representing said first characteristic is outside a first range;
determining a first period representing a time during which said first value is outside said first range;
determining a first flush protocol representing a flushing of a portion of said plumbing system; and
generating a control signal by the computer to implement said first flush protocol if said first value is outside said first range and said first period exceeds a first time threshold.

11. The method of claim 10, wherein said first characteristic is one of a temperature of water, a temperature of air near the plumbing system, and/or a pressure of water in the plumbing system.

12. The method of claim 10, further comprising:
determining a second period representing a time during which a flow rate through the plumbing system is lower than a first flow rate threshold; and
wherein said generating step generates a control signal by the computer to implement said first flush protocol if said first value is outside said first range and said first period exceeds a first time threshold and said second period exceeds a first time threshold.

13. The computer based method of claim 10, wherein said first flush protocol uses at least one of hot water and/or cold water.

14. The computer based method of claim 10, wherein said plumbing system comprises multiple faucets.

15. The computer based method of claim 10, wherein said plumbing system comprises a single faucet.
